(19) United States
(12) Patent Application Publication
(10) Pub. No.: US 2018/0241745 A1
(43) Pub. Date: Aug. 23, 2018

(54) METHOD AND SYSTEM FOR VALIDATING WEBSITE LOGIN AND ONLINE INFORMATION PROCESSING

(71) Applicant: Giovanni Laporta, Watford (GB)

(72) Inventor: Giovanni Laporta, Watford (GB)

(21) Appl. No.: 15/899,533

(22) Filed: Feb. 20, 2018

Related U.S. Application Data
(60) Provisional application No. 62/460,937, filed on Feb. 20, 2017.

(51) Int. Cl. H04L 29/06

(52) U.S. Cl. CPC H04L 63/0853; H04L 63/102; G06F 21/6263; H04L 63/083; H04L 63/0876

(57) ABSTRACT

What is provided is a method and system for simply and securely pairing a web user with a specific URL or online-based content without requiring the user to memorize or enter a specific username or password when accessing a particular webpage. Since usernames, passwords, and other login information are not being displayed or recorded in a tangible form, the risk of an unauthorized party accessing and/or obtaining an individual's personal information and data is greatly reduced.

### PRIORITY CLAIM

This patent application is a Non-Provisional Patent Application and claims priority under 35 U.S.C. 119(e) to U.S. Provisional Patent Application Ser. No. 62/460,937, titled “METHOD AND SYSTEM FOR VALIDATING WEBSITE LOGIN AND ONLINE INFORMATION PROCESSING,” filed Feb. 20, 2017. The entire disclosure of the aforementioned patent application is incorporated by reference as if fully stated herein.

### FIELD

This patent application generally relates to a method and system for improving the validation of website login, payment transactions, and information processing. Specifically, the validation can be achieved by securely pairing a web user with a specific Uniform Resource Locator (URL) or specific online-based content.

### BACKGROUND

The proliferation of the Internet has resulted in an increased need for online security, in the form of usernames and passwords, to ensure the safekeeping of user information from hacking and cybercrime. Users currently must remember and/or store their usernames and passwords to access their respective accounts on various websites, search engines, and social networks. In addition, websites typically require users to regularly change their passwords and/or include uppercase, number, and symbols in order to minimize the risk that their accounts will be accessed by unauthorized third parties. As a result, users are often required to memorize many passwords, many of which can be rather complex.

Consequently, users often forget their usernames and/or passwords and may be temporary locked out of their online accounts. In order to regain access to their online accounts, users are typically sent communications in the form of e-mail messages, text messages, or the like with their usernames and passwords. These messages, though, may be accessed when e-mail accounts or servers are hacked. As a result, private online user accounts are compromised and private information becomes publicly available.

In order to allow users to save time by not re-entering their personal information on various websites, web browsers, such as GOOGLE CHROME®, provide automatic fill features that store and automatically insert the information in the relevant areas. In addition, many websites provide users with the option of having the websites automatically remember user login information, such as usernames and passwords. However, these approaches present some significant risk to the security of personally identifiable information, such as usernames, passwords, credit card/payment information, full names, home addresses, passport numbers, and Driver's License numbers previously provided online by users. By storing user personally identifiable information online through web/online servers, this information is at risk of being accessed by hackers or other undesired third parties.

Accordingly, there exists a need for a method and system for more simply and securely pairing a web user with a specific URL and online-based content without requiring the user to memorize a specific username and password or to enter the username and password online. The method and system should allow the web user to login and access the website associated with the URL and to securely transmit personally identifiable information and data for a variety of purposes, such as, but not limited to website access, payment transactions, and document exchange. Specifically, the method and system should provide a replacement for usernames, passwords, and other login information that may be hacked or accessed by unauthorized individuals. As a result, a more secure method for accessing and transmitting personally identifiable information is needed.

### SUMMARY

The following presents a simplified summary in order to provide a basic understanding of some novel embodiments described herein. This summary is not an extensive overview, and it is not intended to identify key elements or to delineate the scope thereof.

What is provided is a method and system for simply and securely pairing a web user with a specific URL or online-based content without requiring the user to memorize or enter a specific username or password when accessing a particular webpage. Since usernames, passwords, and other login information are not being displayed or recorded in a tangible form, the risk of an unauthorized party accessing and/or obtaining an individual's personal information and data is greatly reduced. Examples of some of the online-based content include, but are not limited to credit card/payment information when making payments and personal information for completing forms.

In exemplary embodiments, the system comprises a non-transitory computer readable medium storing instructions thereon that, when executed by at least one processor, cause the at least one processor to: receive, from a first computing device of a user, a login request corresponding to a uniform resource locator (URL) for the website, wherein the login request comprises a device identification associated with the first computing device and the user's login credentials associated with the URL; generate a unique authentication code for the URL corresponding to the device identification; store, using a non-transitory memory on the first computing device, user's login credentials; and present, via the API server, to the user a first pair number, wherein the first pair number is associated with the URL and visually displayed via a web browser on a second computing device; enter the first pair number on the first computing device within a predetermined time period; identify whether the first pair number was correctly entered by the user on the first computing device; present, via the API server, to the user a second pair number, wherein the second pair number is associated with the URL and visually displayed via the web browser on the second computing device when the first pair number was validated as being entered correctly; enter the second pair number on the first computing device within a predetermined time period; authenticate the user when both the first pair number and the second pair number are validated as being entered correctly; and transmit, via the first computing device, the user's login credentials to the API server for access to the website.

In exemplary embodiments, the method for secure login to a website comprises receiving, from a first computing device of a user, a login request corresponding to a uniform resource locator (URL) for the website, wherein the login request comprises a device identification associated with the first computing device and the user's login credentials associated with the URL; generating a unique authentication code for the URL corresponding to the device identification; storing, using a non-transitory memory on the first computing device, user's login credentials; presenting, via the API server, to the user a first pair number, wherein the first pair number is associated with the URL and visually displayed via a web browser on a second computing device; entering the first pair number on the first computing device within a predetermined time period; identifying whether the first pair number was correctly entered by the user on the first computing device; presenting, via the API server, to the user a second pair number, wherein the second pair number is associated with the URL and visually displayed via the web browser on the second computing device when the first pair number was validated as being entered correctly; entering the second pair number on the first computing device within a predetermined time period; authenticating the user when both the first pair number and the second pair number are validated as being entered correctly; and transmitting, via the first computing device, the user's login credentials to the API server for access to the website.

In exemplary embodiments, another method for validating a user's login credentials involves the use of the web access system to generate a unique URL specific for a web user. The web-access system provides this URL to the web user only after the web user has been properly authenticated with the web-access system. Once a web user is provided with a specific URL for a certain website, the web user can directly access the URL, instead of needing to dynamically pair the mobile computing device with the specific webpage of interest. The web user can readily access the specific webpage by opening the web access application on his/her mobile computing device.

In exemplary embodiments, the method for validating a user's login credentials using the web access system comprises requesting the transmission of a user's login credentials by the API server, requesting the user to complete additional validation measures, such as live photo, live touch, pair key, and block pin, prior to any user personal information being transmitted from the mobile computing device. If the web access system determines that the user validation process is completed successfully (user identity confirmed), then user login information may be transmitted to the API server and matched to the original information provided by the user to the web access system. No user login information is transmitted to the API server if the validation process was not successfully completed. As a result, the user login process may be completed without the display of any user passwords.

In exemplary embodiments, the method for protecting the security of a user's personal data and information using the web access system comprises the web access system providing login credentials to the user only after verifying the user's identity; locking the user's mobile computing device so that only user is associated with that mobile computing device; using a pin block to protect user personal information; restoring the original settings on the user′ mobile computing device, and allowing the user to create a rescue pin for his/her login credentials.

The following detailed description together with the accompanying drawings will provide a better understanding of the nature and advantages of the present invention.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is an exemplary embodiment of a web access system comprising a mobile computing device communicating wirelessly with a host computing device;

FIG. 2 is an exemplary block diagram of the mobile computing device of FIG. 1;

FIG. 3 is a flow diagram of an exemplary method for validating webpage login using the web access system of FIG. 1;

FIG. 4 is a flow diagram of an exemplary method for validating a user's login credentials using the web access system of FIG. 1; and

FIG. 5 is an exemplary method for protecting the security of a user's personal data and information using the web access system of FIG. 1.

### DETAILED DESCRIPTION

In the following detailed description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and components have not been described in detail so as not to obscure the examples defined by the claimed subject matter.

Some portions of the detailed description that follow are presented in terms of algorithms and/or symbolic representations of operations on data bits and/or binary digital signals stored within a computing system, such as within a computer and/or computing system memory. An algorithm is here and generally considered to be a self-consistent sequence of operations and/or similar processing leading to a desired result. The operations and/or processing may take the form of electrical and/or magnetic signals configured to be stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device that manipulates and/or transforms data represented as physical electronic and/or magnetic quantities and/or other physical quantities within the computing platform's processors, memories, registers, and/or other information storage, transmission, and/or display devices.

As used herein, computing device and computer readable storage media do not cover signals or other such unpatentable subject matter. Only non-transitory computer readable storage media is intended within the scope and spirit of claimed subject matter.

Unless specifically stated otherwise, as apparent from the following discussion, it is appreciated that throughout this specification a computing platform includes, but is not limited to, a device such as a computer or a similar electronic computing device that manipulates and/or transforms data represented by physical, electronic, and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instructs a computing platform to perform a certain action, it is understood that “instructs” may mean to direct or cause to perform a task as a result of a selection or action by a user. A user may, for example, instruct a computing platform embark upon a course of action via an indication of a selection, including, for example, pushing a key, clicking a mouse, maneuvering a pointer, touching a touch pad, touching a touch screen, acting out touch screen gesturing movements, maneuvering an electronic pen device over a screen, verbalizing voice commands, and/or by audible sounds. A user may include an end-user.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term “system” may, depending at least in part upon the particular context, be understood to include any method, process, apparatus, and/or other patentable subject matter that implements the subject matter disclosed herein. The subject matter described herein may be implemented in software, in combination with hardware and/or firmware. For example, the subject matter described herein may be implemented in software executed by a hardware processor.

The terms “pair” or “pairing,” as used herein, mean exchanging data and/or information, such as a password, in order to establish a trusted connection.

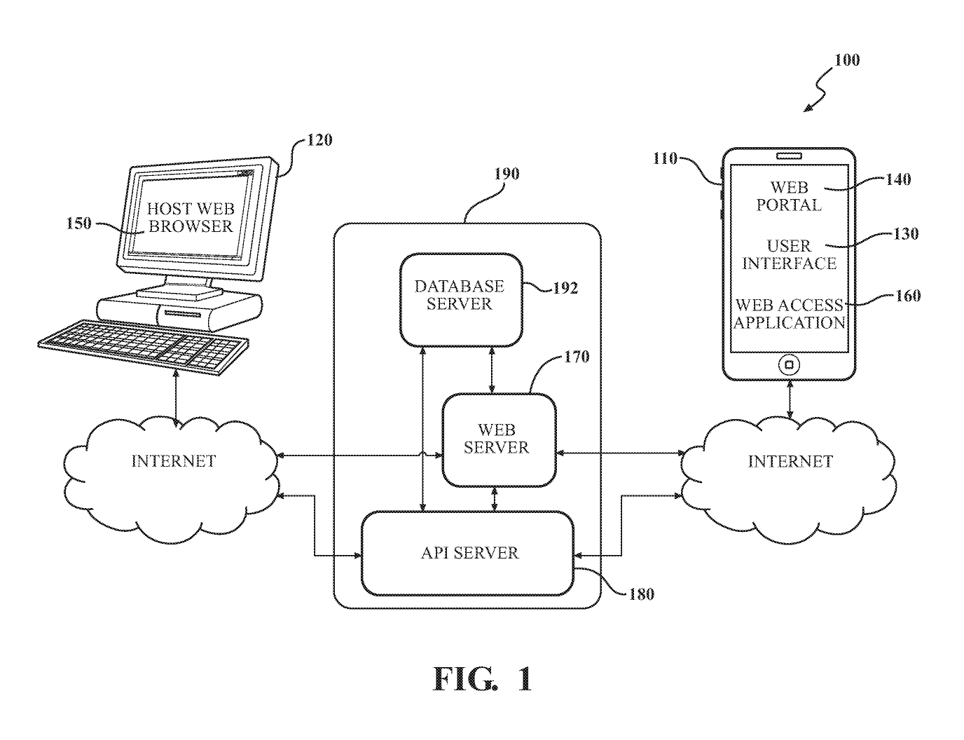

Referring to FIG. 1, FIG. 1 shows an exemplary embodiment of a system 100 for webpage login and online information processing. The system 100 comprises a mobile computing device 110 configured for communicating wirelessly with a secondary computing device, referred to herein as a host computing device 120, and a web access system 190. In this embodiment, the mobile computing device 110 is shown as a smart phone with a graphical user interface (GUI) 130 that allows a user to initiate an action on the mobile computing device 110, such as opening software applications, entering data or information, placing phone calls, or sending text messages.

In other exemplary embodiments, the mobile computing device 110 may be any mobile device that communicates with the host computing device 120 and is configured to have a web browser. Even though the mobile computing device 110 is shown as a smart phone in FIG. 1, other mobile computing devices may be substituted, such as a smart watch, tablet computer, or the like.

The web access system 190 further comprises a web portal 140 that may be displayed by a web access application 160, such as a web browser or application, on the mobile computing device 110. The web portal 140 may be viewable with a standard web browser, such as Internet Explorer®, Mozilla®, Safari® and/or Chrome®. In at least one example, the web portal 140 may be HTML 5 based. Actions communicated on the mobile computing device 110 may be communicated to the web access system 190 via the web portal 140.

The mobile computing device 110 may execute the web access application 160, which may be operated by the user of the mobile computing device 110 to securely login to webpages and websites for a variety of purposes, such as, but not limited to payment transactions, data transfer, website access, and document exchange. The web access application 160 is displayed by the GUI 130, allowing the user to provide information to and receive information from the web access application 160. The web access application 160 may also retrieve data and information stored locally on the mobile computing device 110 and to communicate with the host computing device 120.

The web access system 190 further comprises a web server 170, a database server 192, and an application program interface (API) server 180. The web server 170 communicates with the database server 192 when data from the mobile computing device 110 and the host computing device 120 is viewed and/or modified. The web server 170 is also configured to pair the web user with a specific URL.

The API server 180 is the junction for most of the data transmitted/received by the mobile computing device 110 and the host computing device 120. Third party service providers may communicate directly with the API server 180. Examples of third party providers include those that have an established API that expose functionality with their systems over HTTP.

The operating systems on the mobile computing device 110 and the host computing device 120 may be APPLE® iOS, GOOGLE ANDROID®, or WINDOWS®, or a functionally equivalent operating system. The operating system on the mobile computing device 110 and the host computing device 120 allow the respective user to communicate with the web server 170 for webpage login validation and information processing. Each of the mobile computing device 110 and the host computing device 120 may communicate with the API server 180 for data communication.

In the embodiment shown in FIG. 1, the web server 170 and the API server 180 are located on the same piece of hardware in the web access system 190. In other embodiments, the web server 170 and the API server 180 are located on different pieces of hardware.

The database server 192 provides access to databases for storing all data related to the system 100, including, but not limited to, information and data associated with the mobile computing device 110 and the host computing device 120. The API server 180 serves as the central point for communications between the mobile computing device 110 and the host computing device 120, and Internet-connected third-party servers processing data.

As shown in FIG. 1, the host computing device 120 comprises a host web browser 150 that is used as an interface to the web access application 160 that is responding to the user input on the GUI 130. The host computing device 120 may communicate wirelessly with the mobile computing device 110 using protocols such as Bluetooth or Wi-Fi. In some embodiments, the host computing device 120 may communicate with the mobile computing device 110 using a wired connection through suitable cables. Communication networks may be any combination of wired and/or wireless LAN, cellular and/or Internet communications and/or other local and/or remote communications networks known in the art.

In exemplary embodiments, the host computing device 120 is owned and operated by the same user as the mobile computing device 110. Even though the host computing device 120 is shown as a desktop computer in FIG. 1, other host computing devices may be substituted, such as a laptop computer, tablet, or any other device known in the art that is capable of receiving, storing, and displaying content received from the mobile computing device 110.

The host computing device 120 may use cellular, Wi-Fi, or other networking technologies to connect to the Internet. The host computing device 120 may allow the host web browser 150 to interface with the web access application 160 and to receive messages, data, and information from the web access application 160 on the mobile computing device 110.

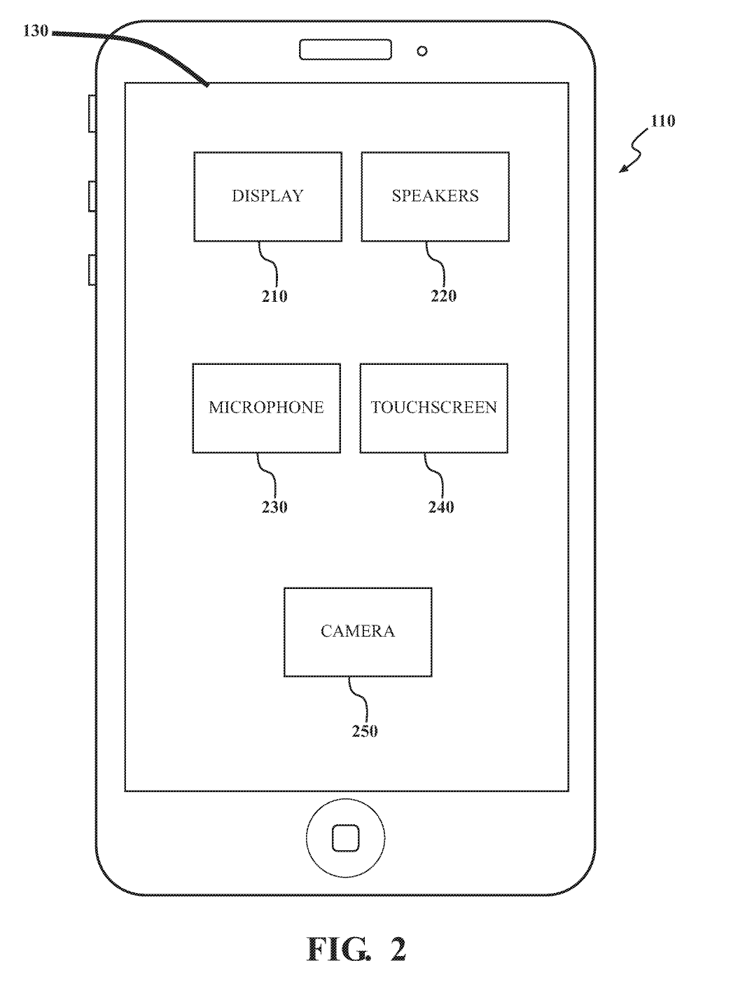

Referring to FIG. 2, FIG. 2 shows an exemplary block diagram of the mobile computing device 110 of FIG. 1. The mobile computing device 110 may include any combination of input and output devices that may be used for inputting data into the web access system 190. Examples of output devices include display 210 and speakers 220. Examples of input devices include microphone 230, touch screen 240, and camera 250. In some embodiments, touch screen 240 can be overlaid over display 210 to provide a touchscreen interface. Camera 250 may include an image sensor and lenses arranged to focus an image onto an image sensor. The camera 250 can use the imaging components to capture still and/or video images.

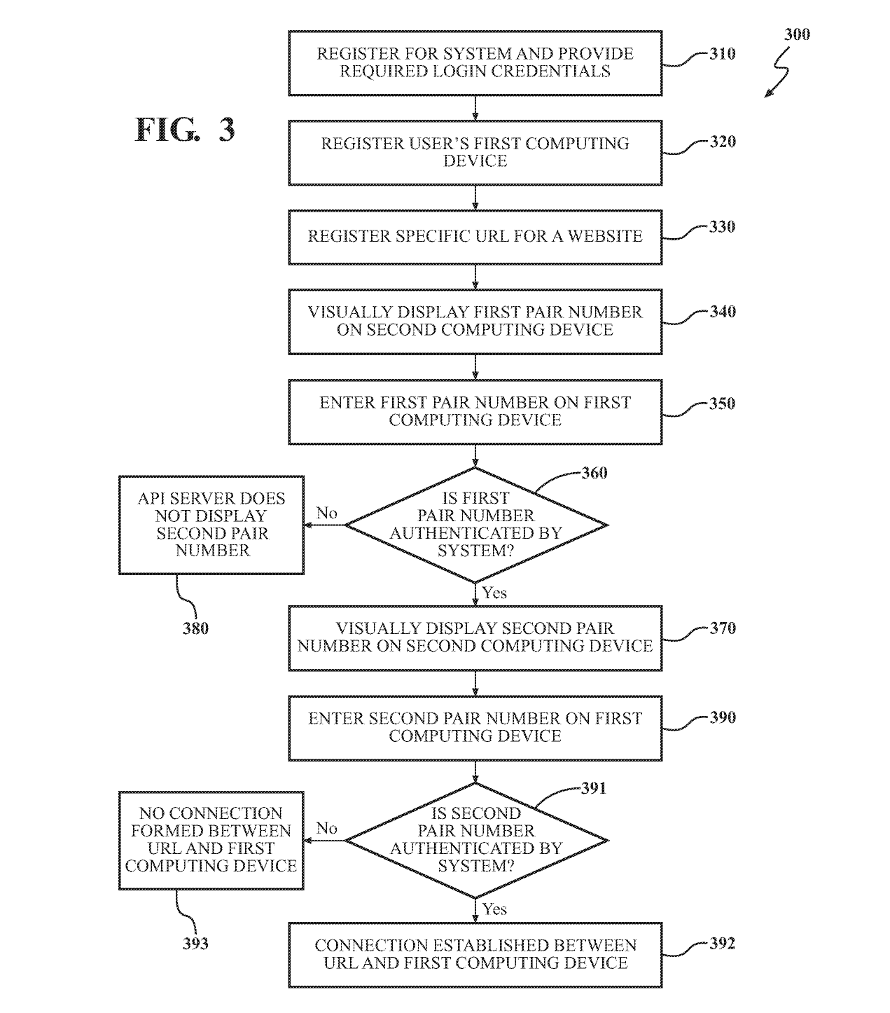

Referring to FIG. 3, FIG. 3 shows a flow diagram of an exemplary method 300 for validating website login using the web access system 190 of FIG. 1. The method 300 can be implemented in the interaction between the mobile computing device 110 and the host computing device 120.

According to block 310, this method 300 commences when the system 100 authenticates the required login information provided by a user. The user provides the required information through the web access application 160 on the mobile computing device 110. In doing so, the user uses the mobile computing device 110 to complete personal data fields in the system 100 in order to limit the amount of information and forms that needs to be provided at a later time. The user also creates a personalized username and password for the system 100, along with block and rescue pins in case the user's mobile computing device 110 is lost, stolen, or misplaced. In some embodiments, the block and rescue pins are at least five digits.

Only non-personally identifiable information of a user, such as first names and images, are provided via the Internet and stored on the web server 170 or any other third-party online server that uses the system 100. The personally identifiable information of the user is only completed locally on the mobile computing device 110 using the web access application 160 and not stored on the web server 170. As a result of not storing using personally identifiable information on online servers, the security liability is mitigated since hackers will have little incentive to access online servers to gain access to the personally identifiable information.

In block 320, the mobile computing device 110 is specifically registered by the system 100, to the user. The system 100 authenticates the phone number associated with the mobile computing device 110 by transmitting a text message with a pin to the phone number. The user may log into the web access application 160 by entering the designated pin number. After the user logs into the web access application 160, the web access application 160 automatically finds and uploads the serial number of the mobile computing device 110. Each data field associated with the user is assigned a hidden data tag ID for data matching by the web access application 160.

In block 330, the user registers a specific URL with the system 100 using the web access application 160. On the webpage associated the URL, the user completes the necessary login information for the webpage, such as the standard username and password associated with the webpage. In some embodiments, the web access system 190 automatically upgrades the login security credentials for the user and the webpage associated with the URL by automatically incorporating a 256-digit ID number specific for the system 100 and the serial number of the mobile computing device 110 to the standard login credentials of the webpage. This ID is known as a UOO 256 ID™. The 256-digit ID number and mobile computing device 110 serial number serve as hidden login credentials for the webpage associated with the desired URL. Each data field associated with the user is assigned a hidden data tag ID for data matching by the web access application 160.

After registering the specific URL with the web access application 160, the API server 180 that is associated with the webpage on the URL can be configured to interact with the web access application 160 on the mobile computing device 110. The API server 180 specifically looks for the user's personally identifiable information, which is only stored on the mobile computing device 110. The user's personally identifiable information is transmitted over the Internet to the host web browser 150 as needed on a transaction-by-transaction basis. The user's personally identifiable information is not permanently stored on the web server 170 or any other web servers.

After selecting a login icon on the webpage associated with the URL of interest, the API Server 180 (also known as the dynamic pair server) visually presents the user with a first pair number to commence dynamic number pairing, as shown in block 340. In most embodiments, the first pair number is displayed through the host web browser 150 of the host computing device 120. However, in some embodiments, the first pair number may be displayed through the web portal 140 on the mobile computing device 110. Even though the first pair number is randomly generated, it is specifically associated with the URL in the system 100. The first pair number may comprise only one digit. In exemplary embodiments, the first pair number comprises at least three digits. From the time that the first pair number is displayed, the user has a predetermined amount of time to read and enter the first pair number into the web access application 160 on the mobile computing device 110. In some embodiments, the predetermined amount of time is 30 seconds. In block 350, the user enters the first pair number on the mobile computing device 110.

As shown in block 360, the system 100 determines whether the first pair number was correctly entered by the user. If the first pair number was correctly entered, the API server 180 associated with the URL of interest visually presents the user with a second pair number, as shown in block 370. The second pair number is not presented on the webpage if the first pair number is not correctly entered by the user on the web access application 160, as shown in block 380. As a result, only one user gets to view a second pair number on the webpage for entering into the system 100.

At least two pair numbers are used in the system 100. The second pair number serves to prevent a user from inadvertently accessing another user's account within the system 100 when the same first pair number is entered. If the same first pair number was correctly entered by an unintended user, it is extremely unlikely that the unintended user would also correctly enter the same second pair number within the predetermined amount of time, particularly since the unintended user is not prompted to enter the second pair number on the webpage. In block 390, the user enters the second pair number on the mobile computing device. The system 100, as shown in block 391, then determines whether to accept the second pair number entered by the user.

The second pair number also comprises at least three digits and in most embodiments, is displayed through the host web browser 150 of the host computing device 120. In some embodiments, the first pair number may also be displayed through the mobile computing web portal 140 on the mobile computing device 110. As with the first pair number, the second pair number is randomly generated and is associated with the URL in the system 100. In some embodiments, the predetermined amount of time to read and enter the second pair number into the system 100 on the mobile computing device 110 is 30 seconds.

In some embodiments, a security feature of the system 100 may be used to further ensure that the pair numbers are only displayed on webpages for predetermined periods of time by randomly changing URL access points and limiting access to the webpages. The security feature adds a long, unique code to the end of the URL associated with the webpage using an MD5 hash code. Within milliseconds after the host web browser 150 opens the webpage with the first pair number, the MD5 hash code is replaced with a defined name by changing the route within the code framework. The randomly changing URL may be known as a jumping URL.

For example, the URL uoo.space/c111119948439843948394834 could be changed to the URL uoo.space/login within milliseconds. The webpage looks the same despite the URL change. Any attempts by the user to refresh this webpage will result in the final uoo.space/login URL. By hitting the “back” button, the user will go to the previous webpage, but will not be able see the original URL or to return to the webpage displaying the pair numbers. Thus, the original URL of the webpage displaying the pair numbers cannot be cut and paste or captured via a screenshot due to its limited time of being displayed. In some embodiments, the security feature for jumping from a unique, user-specific URL to a more general URL is known as JUMP™.

If the second pair number is also correctly entered by the user and accepted by the system 100, a connection is established between the user's web access application 160 on the mobile computing device 110 and the specific URL of interest, as shown in block 392. If the second pair number is not accepted by the system 100, a connection is not deemed to be established between the web access application 160 and the URL through the system 100, as shown in block 393. Thus, the web access application 160 only triggers the transmission of user data and/or information from the web server 170 to the API server 180 when at least two pair numbers have been accepted. The result is that the correct data and information is transmitted through the Internet and that the correct user is viewing the correct webpage associated with the URL of interest.

In some embodiments, accidental number pairing can also be prevented through the use of geo pairing. Geo pairing is a feature of the system 100 that triggers an alert notification to the user when the geographical locations of mobile computing device 110 and host web browser 150 and/or the host computing device 120 don't match in order to prevent access to a webpage due to accidental number pairing by another user. Upon receiving the alert notification, the user can then decide whether to allow the pairing to occur or to override the pairing and prevent the connection between the web access application 160 on the user's mobile computing device 110 and the URL of interest.

The API server 180 then requests the transmission of the user's login credentials from the web access application 160. In doing so, the API server 180 sends a unique tag for each data field of the login credential stored on the mobile computing device 110 in the web access application 160. In some embodiments, the multi-login credentials include the username, password, 256-digit ID, and the serial number of the mobile computing device 110. In order to validate the login credentials, the system 100 confirms that the login credentials from the mobile computing device 110 match the information previously provided by the user to the webpage. If validated, the mobile computing device 110 transmits the multi-login credentials over the Internet to the API server 180, which then opens the webpage and displays the user's personal account. In some embodiments, only the first name and image of the user are required for the user to ensure that he is logged into the correct account.

The login process on the webpage is completed without requiring the user to display or enter a password. Thus, the user does not need to remember, filter, or store any passwords. In addition, the API server 180 does not show or store any of the user's login credentials. This significantly improves the security of the user's data and information.

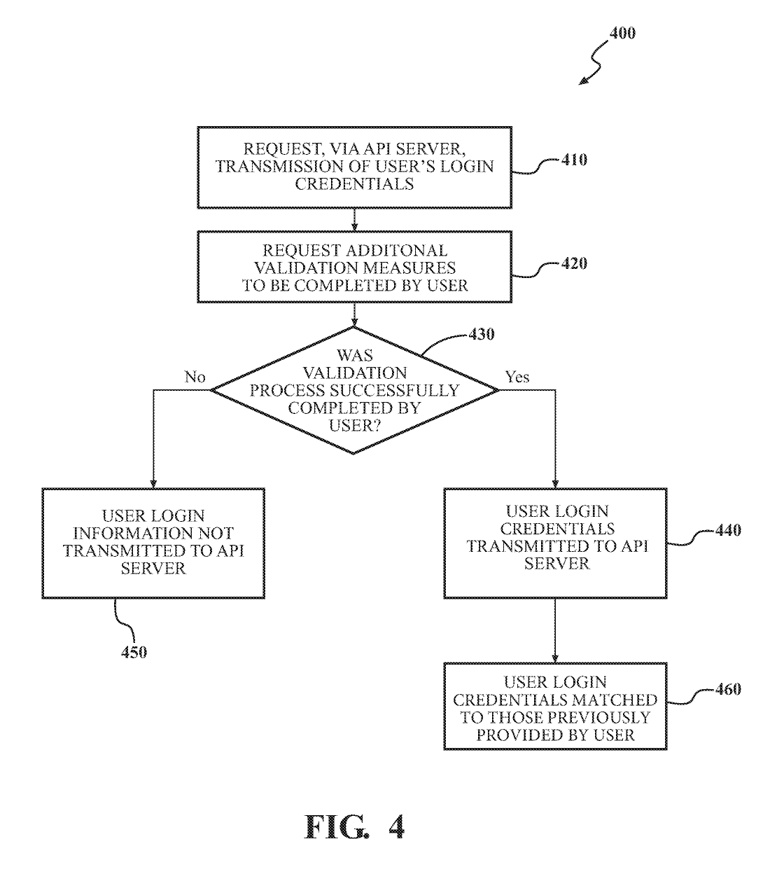

Referring to FIG. 4, FIG. 4 shows a flow diagram of an exemplary method 400 for validating a user's login credentials using the system 100 of FIG. 1. In block 410, the API server 180 requests the transmission of the user's login credentials from the web access application 160. In doing so, the API server 180 sends a unique tag for each data field of the login credential stored on the mobile computing device 110 in the web access application 160. In some embodiments, the multi-login credentials include the username, password, 256-digit ID, and the serial number of the mobile computing device 110. In order to validate the login credentials, the system 100 confirms that the login credentials from the mobile computing device 110 match the information previously provided by the user to the webpage. If validated, the mobile computing device 110 transmits the multi-login credentials over the Internet to the API server, which then opens the webpage and displays the user's personal account. In some embodiments, only the first name and image of the user are required for the user to ensure that he is logged into the correct account.

In block 420, additional validation measures are requested by either the user or the owner/operator of the webpage at issue and these additional validation measures must be successfully prior to the web access application 160 sending the user's login credentials or images from the mobile computing device 110. Examples of additional validation measures that may be used to allow the user to login to a specific webpage from the web access application 160 include live photo, live touch, pair key, and block pin. As shown in block 430, the system 100 determines whether the user validation process was successfully completed.

Live photo involves the use of photoplethysmography (PPG) and direct opening of the camera 250, while the phone library and all other software are blocked from being used by the web access application 160. For convenience, the user may back up his web access application 160 data to a separate pair key that makes it easier to restore personally identifiable information data to a new mobile computing device. The pair key has a dedicated code linked specifically to the user.

In block 440, system 100 completes the validation process and sends the user's login credentials stored on the mobile computing device 110 over the Internet to the API server 180 when the user validation process is successfully completed. The user login credentials transmitted to the API server 180 are matched to those originally provided by the user and stored on the webpage database, as shown in block 460. If the user validation process is not successfully completed in the system 100, the user's login information is not transmitted to the API server, as shown in block 450.

The login process on the webpage is completed without requiring the user to display or enter a password. Thus, the user does not need to remember, filter, or store any passwords. In addition, the API server 180 does not show or store any of the user's login credentials. This significantly improves the security of the user's personal data and information.

In yet another method for validating a user's login credentials using the system 100 of FIG. 1, the system 100 generates a unique URL specific for a web user. The system 100 provides this URL to the web user only after the web user has been properly authenticated with the system 100. This URL is known as the web user's SUPER SPACE™. The URL may be associated with any website, such as Facebook.com, Hotmail.com, Twitter.com, etc.

Once a web user is provided with a specific URL for a certain website, the web user can directly access the URL, instead of needing to dynamically pair the mobile computing device 110 with the specific webpage of interest. The web user can readily access the specific webpage by opening the web access application 160 on his/her mobile computing device 110. The web access application 160 may be opened by the web user through several ways, such as manipulation of the touch screen 240, motion sensitivity (flicking of hand/wrist), and the like.

After the web user accesses the specific URL, the web access application 160 automatically finds and uploads the serial number of the mobile computing device 110. Each data field associated with the user is assigned a hidden data tag ID for data matching by the web access application 160. The web user may be required to complete additional validation measures prior to actually accessing the specific online-based content found on the URL, such as credit card/payment information when making payments and personal information for completing forms. Examples of additional validation measures include, but are not limited to live photo, live touch, pair key, and block pin.

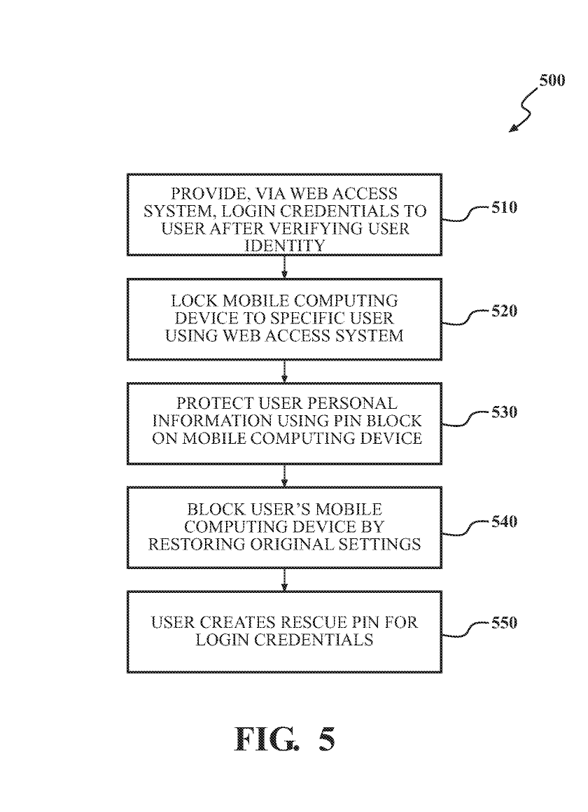

Referring to FIG. 5, FIG. 5 shows an exemplary method 500 for protecting the security of a user's personal data and information using the system 100 of FIG. 1. Since the user's mobile computing device 110 is necessary for logging into a website and accessing the user's personal information, the system 100 may implement measures for protecting the security of the user's personal information, particularly when the user's mobile computing device 110 is lost, misplaced, or stolen or when the user's username and/or password are accessed by an unauthorized third party.

The system 100 only provides login credentials to a user over the mobile computing device 110 after verifying that the user is who he/she claims to be, as shown in block 510. The system 100 does not provide a user with his/her login credentials in written form (email, letter, text message, etc.) to further ensure the security of the user's login information. If the user forgets his/her username or password, the user will need to directly call specific security lines operated by the system 100 for username or password retrieval, respectively. In addition to providing the mobile computing device 110 registered with the system 100, the user is required to correctly answer a series of security questions. Once the user is verified, the system 100 will provide the user with a temporary username that is linked to the user's real username. In some embodiments, the temporary username will remain active for either one use or for one hour, whichever event happens first.

In block 520, the system 100 locks a particular mobile computing device 110 so that only one serial number associated with a particular mobile computing device 110 may be active at any one time. If a user's username and/or password has somehow been comprised, the system 100 will prevent any entry into the system 100 from another mobile computing device, which has a different serial number.

In block 530, the system 100 protects any user personal information stored on the mobile computing device 110 through the use of a pin block on the web access application 160. A user's personal/sensitive information associated with the system 100, such as website URL, username, password, full name, address, scanned government identification, email address, phone number, and credit card/payment information may only be viewed on the mobile computing device 110 through the user's block pin and/or live touch or live photo. This security measure is particularly relevant if/when the mobile computing device 110 is misplaced, lost, or stolen. In exemplary embodiments, the system 100 provides the block pin as a default security feature with the web access application 160.

In block 540, the system 100 may block a user's mobile computing device 110 by restoring the settings on the mobile computing device 110 to the original factory settings next time that the user connects to the web access application 160. Specifically, this involves the user calling the security telephone line associated with the system 100 and providing the operator with their email address and two characters of their block pin.

In some embodiments, as shown in block 550, users of the system 100 are requested to set a rescue pin for their login credentials, in the event that they are put under duress, kidnapped, threatened, or the like. The rescue pin may still let the unauthorized individual login to the web access application 160, but also transmits the location of the mobile computing device 110 and a special alert to the system 100. Thus, the rescue pin serves to protect the user, without alerting the unauthorized individual that the system 100 is aware of the alleged breach of security. In some embodiments, the web access system is known as UOO®.

It will, of course, be understood that, although particular embodiments have just been described, the claimed subject matter is not limited in scope to a particular embodiment or implementation. Likewise, an embodiment may be implemented in any combination of systems, methods, or products made by a process, for example. All user interfaces shown herein are also illustrative. Sizes of user interfaces or graphical elements thereof can be modified according to a particular form factor of a mobile computing device and/or host device.

In the preceding description, various aspects of claimed subject have been described. For purposes of explanation, specific numbers, systems, and/or configurations were set forth to provide a thorough understanding of claimed subject matter. Computer file types and languages, and operating system examples have been used for purposes of illustrating a particular example. However, it should be apparent to one skilled in the art having the benefit of this disclosure that claimed subject matter may be practiced with many other computer languages, operating systems, file types, and without these specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that claims are intended to cover all such modifications or changes as fall within the true spirit of claimed subject matter.

1. A method for secure login to a website, the method comprising:
receiving, from a first computing device of a user, a login request corresponding to a first uniform resource locator (URL) for the website, wherein the login request comprises a device identification associated with the first computing device and the user's login credentials associated with the first URL;
generating a unique authentication code for the first URL corresponding to the device identification;
storing, using a non-transitory memory on the first computing device, user's login credentials;
presenting, via an API server, to the user a first pair number, wherein the first pair number is associated with the first URL and visually displayed via a web browser on a second computing device;
entering the first pair number on the first computing device within a predetermined time period;
identifying whether the first pair number was correctly entered by the user on the first computing device;
presenting, via the API server, to the user a second pair number, wherein the second pair number is associated with the first URL and visually displayed via the web browser on the second computing device when the first pair number was determined to be correctly entered;
entering the second pair number on the first computing device within a predetermined time period;
authenticating the user when both the first pair number and the second pair number are determined as being entered correctly; and
transmitting, via the first computing device, the user's login credentials to the API server for access to the website.

2. The method of claim 1, wherein prior to the receiving, from the first computing device, the login request, the method further comprising authenticating the phone number associated with the first computing device.

3. The method of claim 1, wherein the unique authentication code comprises a 256-digit number.

4. The method of claim 1, wherein the device identification comprises a serial number.

5. The method of claim 1, wherein the first pair number comprises at least three digits.

6. The method of claim 1, wherein the second pair number comprises at least three digits.

7. The method of claim 1, wherein the user's login credentials comprise a username, a password, and a full name.

8. The method of claim 1, wherein prior to transmitting, via the first computing device, the user's login credentials to the API server, the method further comprising capturing a live image of the user using a camera on the first computing device.

9. The method of claim 1, the method further comprising generating a unique, second URL for the website after the user has been authenticated and previously accessed the website, wherein the second URL is specifically associated with the user.

10. The method of claim 1, wherein prior to transmitting, via the first computing device, the user's login credentials to the API server, the method further comprising entering the user's block pin on the first computing device.

11. The method of claim 1, wherein the predetermined time period is about 30 seconds.

12. A system for secure login to a website, the system comprising:
a non-transitory computer readable non-transitory computer readable medium storing instructions thereon that, when executed by at least one processor, cause the at least one processor to:
receive, from a first computing device of a user, a login request corresponding to a uniform resource locator (URL) for the website, wherein the login request comprises a device identification associated with the first computing device and the user's login credentials associated with the URL;
generate a unique authentication code for the URL corresponding to the device identification;
store, using a non-transitory memory on the first computing device, user's login credentials;
present, via an API server, to the user a first pair number, wherein the first pair number is associated with the URL and visually displayed via a web browser on a second computing device;
enter the first pair number on the first computing device within a predetermined time period;
identify whether the first pair number was correctly entered by the user on the first computing device;
present, via the API server, to the user a second pair number, wherein the second pair number is associated with the URL and visually displayed via the web browser on the second computing device when the first pair number was validated as being entered correctly;
enter the second pair number on the first computing device within a predetermined time period;
authenticate the user when both the first pair number and the second pair number are validated as being entered correctly; and
transmit, via the first computing device, the user's login credentials to the API server for access to the website.

13. The system of claim 12, wherein the unique authentication code comprises a 256-digit number.

14. The system of claim 12, wherein each of the first pair number and the second pair number comprises at least three digits.

15. The system of claim 12, wherein the user's login credentials comprise a username, a password, and a full name.

16. The system of claim 12, wherein the device identification comprises a serial number.

17. The system of claim 12, wherein the system further comprises a camera on the first computing device, wherein the camera is configured to capture a live image of the first user.

18. The system of claim 17, wherein the live image of the first user is captured using photoplethysmography.

19. The system of claim 12, wherein the predetermined time period is about 30 seconds.
